(19) United States
(12) Patent Application Publication
(10) Pub. No.: US 2011/0307243 A1
(43) Pub. Date: Dec. 15, 2011

(54) MULTILINGUAL RUNTIME RENDERING OF METADATA

(75) Inventors: Patrick Miller, Sammamish, WA (US); Daniel Kogan, Issaquah, WA (US); Graham McMynn, Redmond, WA (US)

(73) Assignee: MICROSOFT CORPORATION, Redmond, WA (US)

(21) Appl. No.: 12/797,962

(22) Filed: Jun. 10, 2010

(51) Int. Cl. G06F 17/28; G06F 17/20

(52) U.S. Cl. 704/4; 704/7; 704/8

(57) ABSTRACT

Translated versions of metadata are provided to a user at runtime based on a working language selection. Translated versions of metadata in secondary languages are associated with an original version in a primary language as properties instead of being separate items within an infrastructure hierarchy. The property may be selected from a look-up field at runtime based on user selection of automatic determination of a desired working language. If a translation of a particular item in the working language does not exist, the default language (primary language) version is used instead.

### BACKGROUND

With the proliferation of networking and network based processing, web based services and web applications are taking over the traditional computing tasks performed by locally installed applications. Locally installed applications, as their name suggests, need to be installed, maintained, and updated at the local level making it difficult to manage larger systems such as enterprise computing systems, where hundreds or thousands of users need attention and support of the information technology personnel. Web applications, on the other hand, are accessed by users through thick or thin clients with much easier maintenance since there is one main application to be installed, maintained, and updated. An illustrative example of web based applications is document sharing services, which provide document creation, editing, and sharing services through a simple user interface such as a browsing application user interface. Because the application is centrally managed, many features that were difficult of impractical in locally installed applications may be provided. One such feature is multilingual document support.

Some document sharing sites facilitate multilingual solutions. Such sites may manage multiple copies of the site collection, or a portion of the site collection, to implement one or more translations of the content. Typically, each copy represents a separate language and one copy may be flagged as the source label, or the language that all the others are based on. When a content owner publishes a new major version of a page in the source label, the infrastructure may create a copy of the page in each of the other version in the hierarchy of the site collection. In conventional systems, these copies are not references to the source page; they are copies. Thus, if the source page changes and is republished, the associated copies need to be refreshed with the updated content and must then be retranslated.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing translated versions of metadata to a user at runtime based on a working language selection. According to some embodiments, translated versions of metadata in secondary languages may be associated with an original version in a primary language as properties instead of being separate items within an infrastructure hierarchy. The property may be selected from a look-up field at runtime based on user selection of automatic determination of a desired working language. If a translation of a particular item in the working language does not exist, the default language (primary language) version may be used instead.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating how multilingual versions of metadata may be rendered in a system according to embodiments;

FIG. 2 is an example screenshot of a document sharing service user interface with a look-up field enabling users to view translated versions of available items according to embodiments;

FIG. 3 is a conceptual diagram illustrating runtime rendering of multilingual metadata in a system according to embodiments;

FIG. 4 is a networked environment, where a system according to embodiments may be implemented;

FIG. 5 is a block diagram of an example computing operating environment, where embodiments may be implemented; and

FIG. 6 illustrates a logic flow diagram for a process of rendering multilingual metadata according to embodiments.

### DETAILED DESCRIPTION

As briefly described above, multilingual capacity of a hierarchical metadata structure may be leveraged to display translated versions of actual user data. A look-up field associated with available items may be extended to change a target field at runtime based on a current user language preference. The look-up list may be populated with translated languages and supported languages (with the system default filling in if a translation does not exist), and the correct field may be displayed to the user. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for managing networked computer systems, which may provide multilingual metadata rendering support. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

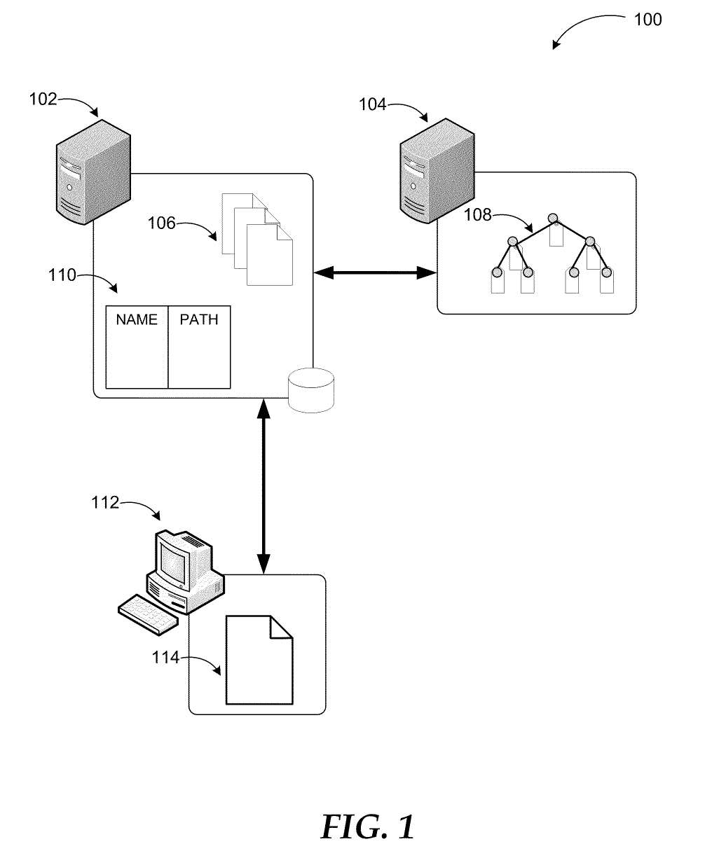

FIG. 1 includes conceptual diagram 100 illustrating how multilingual versions of metadata may be rendered in a networked system. According to some embodiments, a context-aware dynamic show field may be provided in a look-up table (e.g. look-up table 110). Thus, the system is capable of rendering the desired translated string. Furthermore, logic for handling fall back when the desired language is unavailable enables rendering of default language version(s) if the translated version is not available for a particular item in the hierarchy. The data 106, to which the multilingual runtime rendering is applied, includes user content, and is not simply a language pack that is installed on a target system.

A system according to embodiments is established on an underlying taxonomy hierarchy 108 with a notion of translations for each node or “term” in the hierarchy. A de-normalized cache may be utilized in the same system as the rest of the user content. For example, if a document with the term “car” is being tagged, the taxonomy system 104 may be in a totally different part of the enterprise than the document itself. Yet, the look-up table 110 is stored in the same system 102 as the document, and the taxonomy system 104 is projected into this system.

As the taxonomy system 104 and content systems 102 are updated, a background job module may keep the look-up table 110 up-to-date by updating path information, changing translations, and adding columns to the look-up table as languages are added to the system. By projecting the taxonomy data into the content space, the projected values in the content space can continue to be displayed to the users even if the taxonomy system is down for maintenance or hardware/software issues. Additionally, the taxonomy display data can be retrieved more efficiently because it is in the same system as the content. The document 114 with translations may be rendered at any client application/device 112 through a networked system.

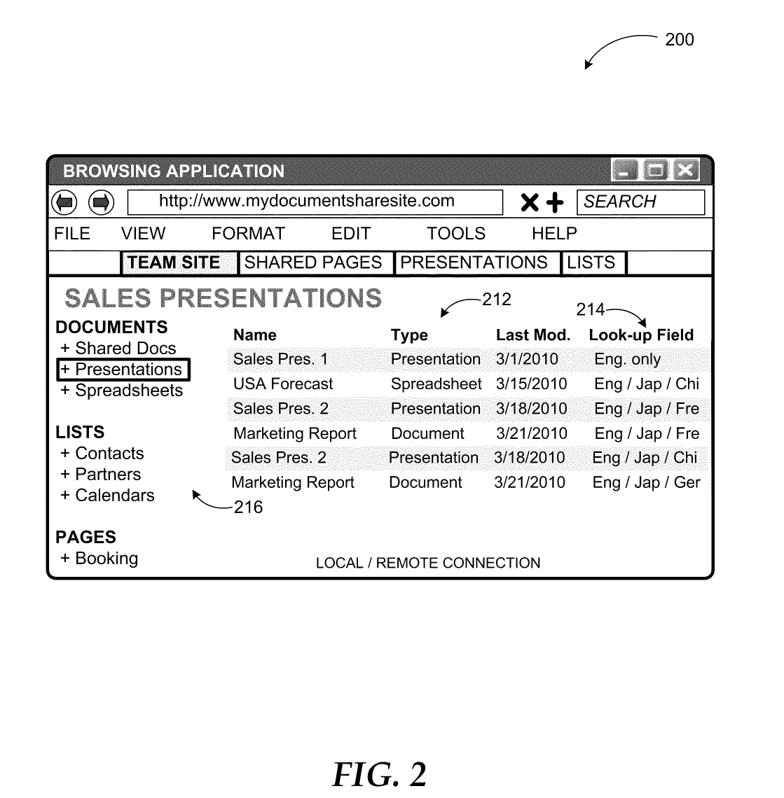

FIG. 2 is an example screenshot of a document sharing service user interface with a look-up field enabling users to view translated versions of available items according to embodiments. In a system according to embodiments, the multilingual capacity of a taxonomical hierarchy system with multiple language versions of terms in the hierarchy is leveraged to display a desired translation user data. According to some embodiments, this may be accomplished by extending a look-up field to change its target field at runtime based on current language preferences of a user. A look-up list associated with the look-up field may be populated with all translated languages and supported languages such that a translation in the preferred (or selected) language is displayed to the user.

The screenshot 200 of FIG. 2 is a web browser user interface displaying a document sharing service's list page. A list of available documents 212 is presented among other standard controls such as menu items, tabs, web site address, a search box, and so on. A collapsible tree view 216 of available items categorized by functionality, type, content, etc. may be presented next to the list of documents 212, which includes a name of each document, a type of each document, and a last modification date of each document.

The example page in screenshot 200 illustrates language selection at document level. According to other embodiments, the rendered page may include a language picker element through which a user may be enabled to modify the language (e.g. choose English, Japanese, Chinese, etc.) and based on their choice from the language picker element, the look-up column 214 may modify what it renders. The available languages are at a server level whereas the translations are performed per term (i.e. one term may have all of the available translations whereas another term may only have an English definition). When a translated version is unavailable, the default language version of the term may be rendered.

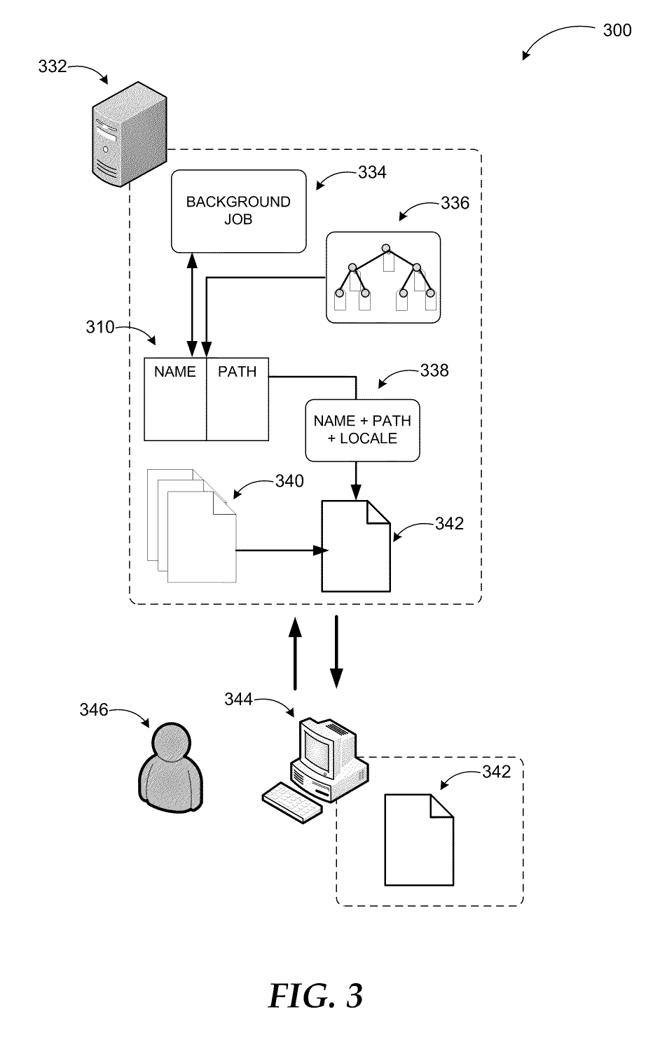

FIG. 3 includes conceptual diagram 300 illustrating runtime rendering of multilingual metadata in a system according to embodiments. As mentioned previously, a look-up table 310 may be employed to enable rendering of translated data 342 based on an underlying taxonomical hierarchy structure 336.

According to some embodiments, the look-up table 310 may include two columns for supported languages in the system: one for the name of the term itself; and one for the term including its path in the hierarchy (e.g. “Redmond” and “North America>Washington>Redmond”). The first time a given term from a given term set is used in the system, an entry may be added to the look-up table, and the values from the taxonomical hierarchy 336 may be copied into it. At runtime (or render time), the column from the look-up table that is displayed may be a combination of the term name or term path and the current display locale (338). For example, “Term1033” for the English node name or “Path1041” for the Japanese path name. As the taxonomy system and content systems are updated, a background job module 334 may keep the look-up table 310 up-to-date.

The data 342, to which the multilingual runtime rendering is applied, may include user content based on stored user content 340. Data 342 may then be rendered through a client application/device 344 to user 346. A language preference of the user 346 may be determined based on user indication, user credentials, automatic detection of locale, or similar automated methods. The data may include textual strings such as words, word groups, and similar ones. The languages may include national languages, dialects, or cultural languages based on specific social groups. For example, legal profession, medical profession, computer science professions, religious professions, and similar ones may develop their own vocabulary with different words or meanings assigned to word (or phrases). Thus, a system according to embodiments may provide translated versions of terms from one sub-group to another. Some translations may result in multiple terms or descriptions being mapped to a single term in the original language.

By using a property based taxonomical hierarchy, the multilingual rendering system may handle many-to-one mappings without having to maintain complex relationships between nodes of the hierarchy and overly complicating the look-up table. Furthermore, absence of translation into a working language for some terms in the rendered data set may be managed by providing the default language version.

The example systems in FIG. 1 through 3 have been described with specific components such as hierarchic schemas, translations, and configurations. Embodiments are not limited to multilingual runtime rendering of data according to these example configurations. Furthermore, specific orders of operations are described for providing hierarchies with multiple language support. Embodiments are also not limited to the example orders of operations discussed above.

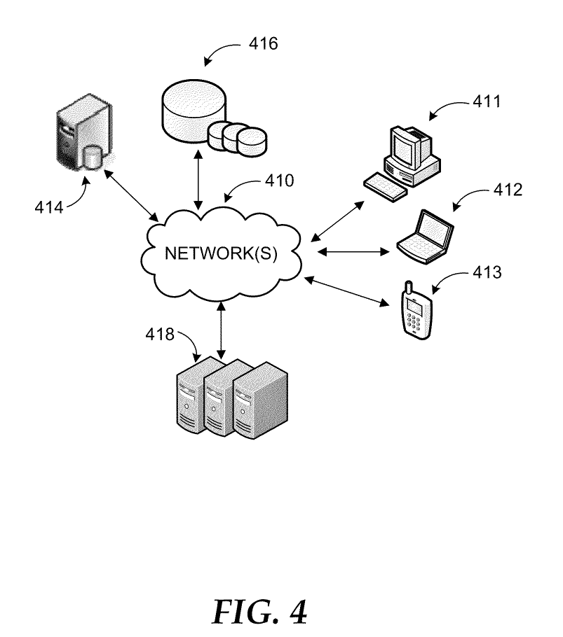

FIG. 4 is an example networked environment, where embodiments may be implemented. A web based application providing multilingual runtime rendering capability for hierarchically structured metadata and content may be implemented via software executed over one or more servers 418 such as a hosted service. The system may facilitate communications between client applications on individual computing devices such as a smart phone 413, a laptop computer 412, and desktop computer 411 (‘client devices’) through network(s) 410.

As discussed previously, a context-aware dynamic show field may be provided in a look-up table for rendering desired translated strings based on a property based hierarchical data structure. Default language version(s) may be rendered if the translated version is not available for a particular item in the hierarchy.

Client devices 411-413 may be thin clients managed by a hosted service. One or more of the servers 418 may a web based application or similar hosted service for rendering multilingual metadata. Data such as the translations, look-up table, and original terms may be stored in one or more data stores (e.g. data store 416), which may be managed by any one of the servers 418 or by database server 414.

Network(s) 410 may comprise any topology of servers, clients, Internet service providers, and communication media. A system according to embodiments may have a static or dynamic topology. Network(s) 410 may include a secure network such as an enterprise network, an unsecure network such as a wireless open network, or the Internet. Network(s) 410 may also coordinate communication over other networks such as PSTN or cellular networks. Network(s) 410 provides communication between the nodes described herein. By way of example, and not limitation, network(s) 410 may include wireless media such as acoustic, RF, infrared and other wireless media.

Many other configurations of computing devices, applications, data sources, and data distribution systems may be employed to implement multilingual runtime rendering of metadata. Furthermore, the networked environments discussed in FIG. 4 are for illustration purposes only. Embodiments are not limited to the example applications, modules, or processes.

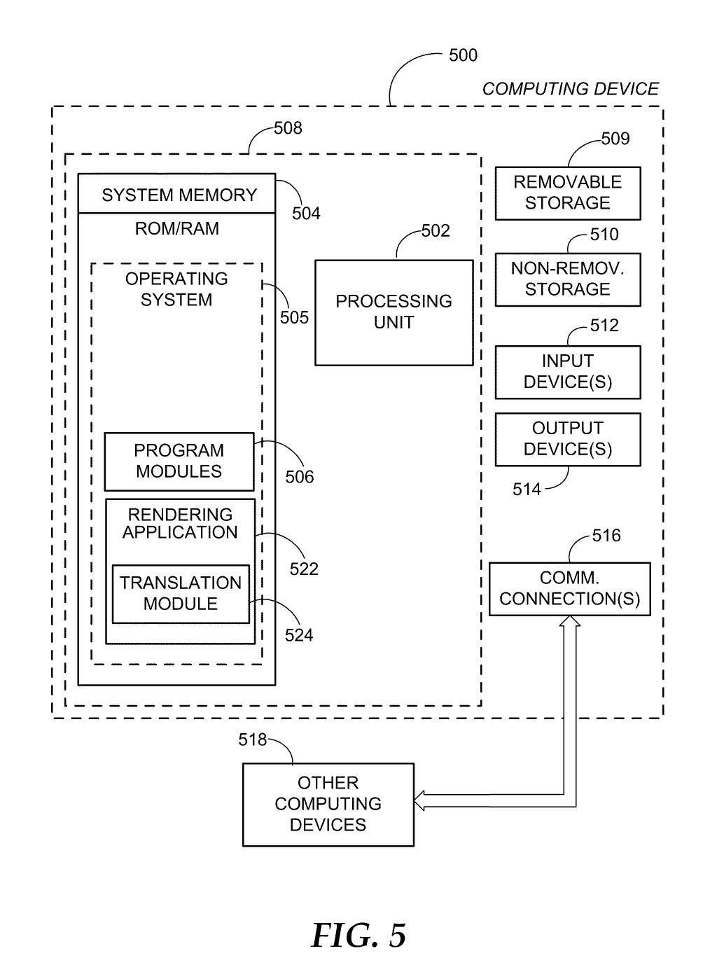

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may be a server providing a web based application and include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS® operating systems from MICROSOFT CORPORATION of Redmond, Wash. The system memory 504 may also include one or more software applications such as program modules 506, rendering application 522, and translation module 524.

Rendering application 522 may render items through a web based application such as documents in a document sharing service. Textual items in an original language may be translated into supported secondary languages by translation module 524 or received from an external source and made available as properties of the original item through a look-up field. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wired or wireless network in a distributed computing environment, a satellite link, a cellular link, a short range network, and comparable mechanisms. Other devices 518 may include servers, desktop computers, handheld computers, and comparable devices. Communication connection(s) 516 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

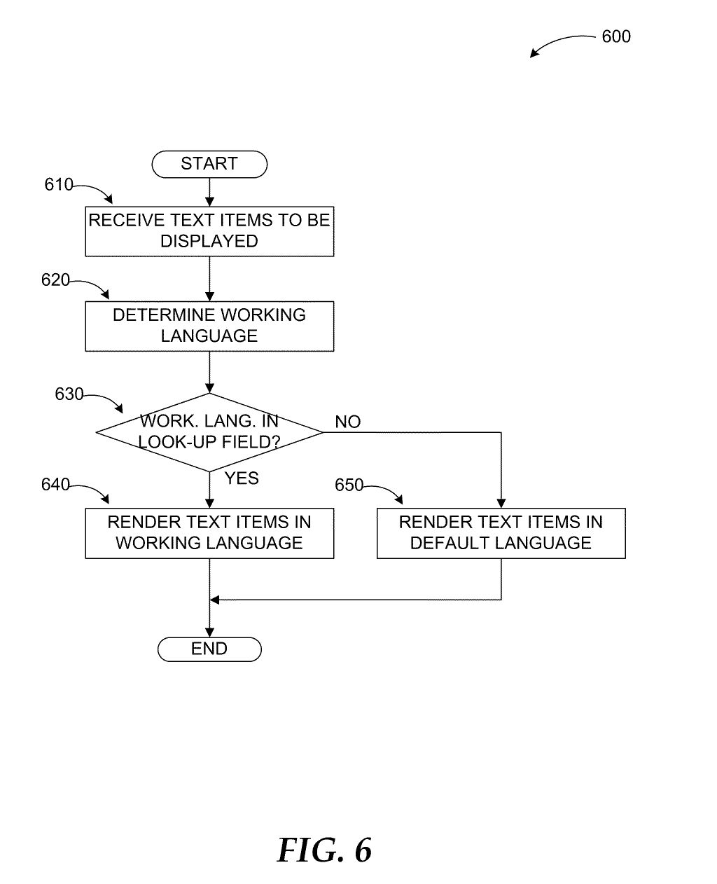

FIG. 6 illustrates a logic flow diagram for process 600 of multilingual runtime rendering of metadata according to embodiments. Process 600 may be implemented as part of a networked application providing multilingual data rendering.

Process 600 begins with operation 610, where text items to be displayed are received. The text items may be terms represented as nodes in a taxonomical hierarchy structure. Translations of the terms may be associated with each term (node) as properties of the nodes instead of additional nodes or duplicate hierarchical structures. At operation 620, a working language (or desired language by the user) may be determined. This may be done based on received user indication or an automated method such as detecting user locale, credentials, user's language choice in another application, and similar approaches.

At decision operation 630, a determination may be made whether the working language is represented in the look-up field for the particular term. If the working language does exist in the look-up field (i.e. a translation of the term in the working language is in the system), the item may be rendered in the working language. If the working language is not in the look-up field for the particular item, however, the item may be rendered in the default language. The data may be rendered as a document, a web page, and/or a selectable tree view through a client application.

The operations included in process 600 are for illustration purposes. Multilingual runtime rendering of metadata according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device for runtime rendering of multilingual data based on taxonomical hierarchies, the method comprising:
receiving data in a default language to be rendered, wherein the data is organized in an underlying taxonomical hierarchy;
determining at least one working language to be used in rendering the data;
determining whether a working language translation of the data is included in a look-up table; and
if the working language translation is included in the look-up table, retrieving the working language translation and rendering the data in the working language translation;
else rendering the data in the default language.

2. The method of claim 1, wherein the underlying taxonomical hierarchy includes a plurality of terms in the default language represented by corresponding plurality of nodes and available translations of each term associated with a corresponding node for the same term as a property of the node.

3. The method of claim 2, wherein the data includes user content with each term including one of: a character string, a word, a group of words.

4. The method of claim 1, wherein the look-up table includes context aware look-up fields for individual terms within the data.

5. The method of claim 4, wherein the look-up table includes, for each supported language, a column representing names of terms and a column representing paths of the terms within the taxonomical hierarchy.

6. The method of claim 4, further comprising:
adding a new entry to the look-up table for a first time rendering of a term;
copying default language and translated versions of the term into the look-up table from the underlying taxonomical hierarchy; and
at runtime providing a combination of a name of the term, a path of the term within the hierarchy, and a current display locale to a rendering application.

7. The method of claim 1, further comprising:
updating the look-up table in response to a change in the underlying taxonomical hierarchy representing the data.

8. The method of claim 7, wherein updating the look-up table includes at least one from a set of: updating path information for nodes of the hierarchy, modifying translations, adding new columns corresponding to newly added translation languages, and removing columns corresponding to deleted translation languages.

9. The method of claim 1, wherein determining the working language includes at least one from a set of: receiving a user indication, determining based on user credentials, determining based on automatic detection of user locale, and determining based on user language preference for another application.

10. The method of claim 1, wherein the data is rendered as one of: a document, a web page, and a selectable tree view through a client application.

11. The method of claim 1, wherein a plurality of terms in a translated language are mapped to a term in the default language.

12. A system for runtime rendering of multilingual data based on taxonomical hierarchies, the system comprising:
a first server configured to execute an application rendering multilingual versions of user data, wherein the application is configured to:
receive the user data in a default language to be rendered, wherein the data is organized in an underlying taxonomical hierarchy of a plurality of terms in the default language represented by corresponding plurality of nodes and available translations of each term associated with a corresponding node for the same term as a property of the node;
determine at least one working language to be used in rendering the data;
determine whether a working language translation of the data is included in a look-up table of context aware look-up fields for individual terms within the data; and
if the working language translation is included in the look-up table, retrieve the working language translation from the look-up table and render the data in the working language translation; else
render the data in the default language.

13. The system of claim 12, wherein the application is further configured to:
create a row in the look-up table for a first time rendering of a term;
copy default language and translated versions of the term into the look-up table from the underlying taxonomical hierarchy; and
at runtime provide a combination of a name of the term, a path of the term within the hierarchy, and a current display locale to a rendering module of the application.

14. The system of claim 12, wherein the first server further executes a backup job module configured to:
update path information in the look-up table for nodes of the hierarchy;
modify translations in the look-up table;
add new columns corresponding to newly added translation languages in the look-up table; and
remove columns corresponding to deleted translation languages in the look-up table.

15. The system of claim 12, further comprising:
a second server managing the taxonomical hierarchy;
a first data store accessible to the first server for storing the look-up table and the user data; and
a second data store accessible to the second server for storing the taxonomical hierarchy.

16. The system of claim 15, wherein the first data store is a de-normalized cache.

17. The system of claim 12, wherein the translations include at least one from a set of: a national language, a dialect, and a cultural language.

18. A computer-readable storage medium with instructions stored thereon for runtime rendering of multilingual data based on taxonomical hierarchies, the instructions comprising:
receiving user data in a default language to be rendered from an underlying taxonomical hierarchy maintaining a plurality of terms in the default language represented by corresponding plurality of nodes and available translations of each term associated with a corresponding node for the same term as a property of the node;
determining at least one working language to be used in rendering the user data;
determining whether a working language translation of the user data is included in a look-up table that includes, for each supported language, a column representing names of terms and a column representing paths of the terms within the taxonomical hierarchy; and
if the working language translation is included in the look-up table, retrieving the working language translation from the look-up table and rendering the user data in the working language translation; else
rendering the user data in the default language.

19. The computer-readable medium of claim 18, wherein rendering the user data includes providing a combination of a name of the term, a path of the term within the hierarchy, and a current display locale to a rendering application at runtime.

20. The computer-readable medium of claim 18, wherein the instructions further comprise:
replacing the default language with one of the supported languages; and
updating the look-up table by replacing corresponding columns.
